(19) United States
(12) Patent Application Publication
(10) Pub. No.: US 2013/0067710 A1
(43) Pub. Date: Mar. 21, 2013

(54) Magnetic Pinion Shaft Seal Installation Tool

(71) Applicants: Danny Williams, Clarinda, IA (US); Brent M. Batterman, Lihue, HI (US)

(72) Inventors: Danny Williams, Clarinda, IA (US); Brent M. Batterman, Lihue, HI (US)

(73) Assignee: Lisle Corporation, Clarinda, IA (US)

(21) Appl. No.: 13/237,585

(22) Filed: Sep. 20, 2011

(51) Int. Cl. B25B 27/02

(52) U.S. Cl. 29/275

(57) ABSTRACT

A tool for replacing a seal on a shaft includes a cylindrical drive member with concentric, axial counterbores forming a through passage that receives a drive handle from either end of the drive member. Magnetized opposite end faces retain differently sized seals thereon whereby a seal mounted on either end face may be driven onto a shaft by inserting and driving the drive handle at the opposite end.

### BACKGROUND OF THE INVENTION

In a principal aspect, the present invention relates to a tool for installation of shaft seals and, more particularly, to an installation tool useful for effecting installation of annular seals that may be fitted over or onto a shaft.

Motor vehicles and other machinery incorporate various shafts associated with the drive train and other mechanical parts of such equipment. These shafts are generally mounted with the support of bearings and seals. A typical seal may have an annular configuration. The seal is fitted about the shaft.

Often it is necessary to remove and replace a seal in such an assembly and the task of a mechanic to effect removal and replacement of a seal can be challenging because of the tightness of the fit of the seal and the location of the seal. Further, seals are made in a multiplicity of sizes. Thus, often a mechanic must use means that will enable the installation of seals having different sizes thereby necessitating multiple tools or a tool kit.

A further complication may result because of the location of the seal. Access for a mechanic to effect replacement is often very limited. That is, the disassembly of a particular item of machinery or vehicle is preferably minimized in order to enable efficient and timely replacement of seals. However, restricted space available for access to a shaft assembly may necessitate undesirable disassembly of shaft mounting arrangements in order to adequately secure access to the seal which is to be replaced.

Yet another problem encountered occurs with respect to replacement of pinion shaft seals because the pinion of the shaft typically projects through and beyond the seal. Removal and replacement of a seal in this circumstance may be especially challenging, particularly when contrasted with seal replacement when there is no pinion shaft projection extending beyond the seal.

To address these issues, various tools have been proposed and made available to assist the replacement of a seal on a shaft including a pinion shaft. By way of example, Kent Moore makes a shaft seal installation tool which comprises a molded plastic assembly having a generally cylindrical shape and onto which a seal may be fitted for driving into a housing for the seal. Such a product is illustrated in FIG. 1 of the present application. Other prior art shaft seal installation tools are depicted in FIGS. 2, 3 and 3A or disclosed in U.S. Pat. No. 7,707,709.

While such tools are useful, they may not resolve the issues and problems described. Thus, there has remained the desire for an improved pinion shaft seal driver tool or tool kit.

### SUMMARY OF THE INVENTION

Briefly the present invention comprises a shaft seal driver tool or assembly for installing pinion shaft seals and other similar seals into position on or over a shaft. The seal driver tool or assembly comprises two principal component parts; namely, a unitary driver and a separate handle which is designed to cooperatively engage the driver so that a seal retained by the driver may be driven into place, for example, over or onto a shaft such as a pinion shaft. The driver is typically comprised of a cylindrical housing or body having an array of concentric passages including a counterbore passage for receipt of the handle at least at one end of the body and a face and counterbore for receipt or placement of a seal on the opposite end. The seal is held in place on the face by magnetic force, e.g. magnets embedded in the driver body. Thus, magnets incorporated into an end face of the driver hold a seal in place for ultimate positioning about a pinion shaft and into a seal housing. The driver is a unitary element and can support different sizes of seals.

The separate handle is insertable into a counterbore of the driver on the end of the driver body opposite the seal support face. In one embodiment the handle may be engaged with the driver body from either end thereof and the opposite ends of the driver body are each capable of magnetically holding a seal. Thus, the driver may be reversible enabling the driver to accommodate seals of multiple or various sizes and driven from either end. The tool may be used to effect replacement of pinion shaft seals as well as seals which are inserted into a recessed opening or seal housing.

As a further aspect of the invention the driver comprises a unitary element or body member with multiple, coaxial counterbores which, in combination, form a passage through the body member so that a pinion shaft may fit into the driver body member and a seal may be positioned about or around and over the pinion shaft and into a seal housing by the tool.

As another aspect of the invention, the separate handle is hollow and slidably insertable into either end of the unitary driver or body member.

As another aspect of the invention, the handle includes a driven end with a cap that may be engaged by a hammer or driving tool to facilitate the insertion of a seal by the driver or body member.

As a further aspect of the invention, the unitary driver or body member and separate handle may be formed from a non-magnetic material such as aluminum and the magnetic feature of the tool may be provided by small magnets fitted or embedded in the ends of the unitary driver. The magnets may be, for example, neodymium magnets and may be arrayed in a circumferential pattern around the periphery at the opposite ends of the driver body to thereby provide a balanced magnetic field or force to retain a seal in position prior to insertion over or on a shaft.

A single driver having opposite ends each of which can serve to receive and mount a seal provides a tool wherein multiple sizes of seals can be positioned using the tool. However, multiple sizes of drivers may be constructed with variable sizes of counterbores for installing multiple sizes of seals. Thus a kit may be provided with multiple driver body sizes having configurations cooperative with a single handle size to enable the use of the tool with a wide variety of seal sizes.

An object of the invention, therefore, is to provide an inexpensive yet essentially universal seal driver tool which is rugged and versatile.

Another object of the invention is to provide a seal driver tool which is easy to use and capable of a wide range of applications for situations such as pinion shaft seal replacement as well as replacement of seals in a flat seal housing or groove.

These and other aspects, objectives and features of the invention will be set forth in greater detail in the description which follows.

### BRIEF DESCRIPTION OF THE DRAWING

In the detailed description which follows reference will be made to the drawing comprised of the following figures:

FIG. 1 is an isometric view of a known prior art seal installation tool of a type made by Kent Moore;

FIG. 2 is an isometric view of an axial shaft seal installation tool such as available from Lisle Corporation Clarinda, Iowa Product No. 38060;

FIGS. 3 and 3A are isometric views of a prior art axial seal installation tool made by Lisle Corporation, Clarinda, Iowa Product No. 17850;

FIG. 4 is an exploded side elevation of the pinion shaft seal driver tool assembly of the present invention;

FIG. 5 is a side elevation of the tubular section of the handle of the tool of FIG. 4;

FIG. 6 is an end elevation of the handle of FIG. 5;

FIG. 7 is an end elevation of the unitary driver or unitary body member of the seal driver tool assembly of the invention;

FIG. 8 is a sectional view taken along the line 8-8 of FIG. 7 also depicting the placement of a seal and the handle for driving the body member and the seal;

FIG. 9 is an opposite end view of the unitary driver of FIG. 8 opposite the view of FIG. 7;

FIG. 10 is an exploded isometric view of a differential housing with a pinion shaft and a seal maintained in position for placement onto the shaft by the tool;

FIG. 11 is an isometric partial view of a differential housing carrier showing the pinion shaft extending past the installed seal surface; and

FIG. 12 is an isometric view illustrating the use of the pinion shaft seal driver tool assembly of the invention.

### DESCRIPTION OF AN EMBODIMENT OF THE INVENTION

FIGS. 1, 2, 3 and 3A depict prior art devices designed to effect installation of shaft seals. In FIG. 1, the device is comprised of a molded plastic body 20 with a projecting cylindrical end section 22 and a seal receiving end section 23 with an annular seal retention ring 24. An annular seal may be fitted over the ring 24 and then the tool may be positioned by gripping or hammering to push or insert the seal into a seal housing. A separate tool of the type shown in FIG. 1 is required for each and every size of seal.

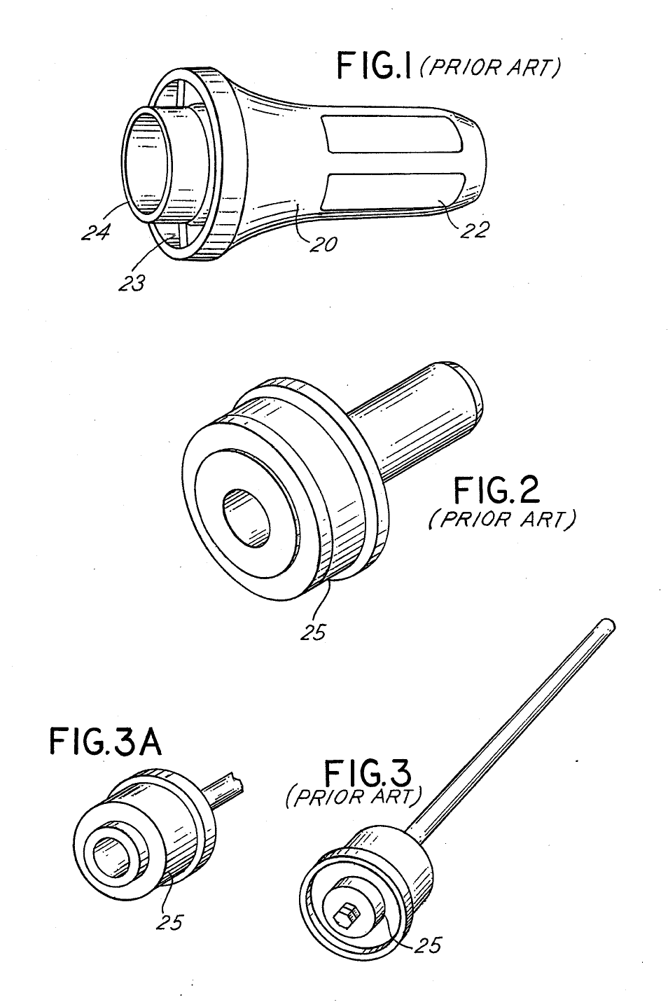

FIGS. 2, 3 and 3A illustrate seal drivers or seal installation tools of very similar construction. That is, an annular seal is fitted over a ring section 25 at one end of the tool. The opposite end of the tool may be driven to effect insertion of the seal into a housing. Similar driving assemblies are depicted in U.S. Pat. No. 7,707,709 which is incorporated herewith by reference.

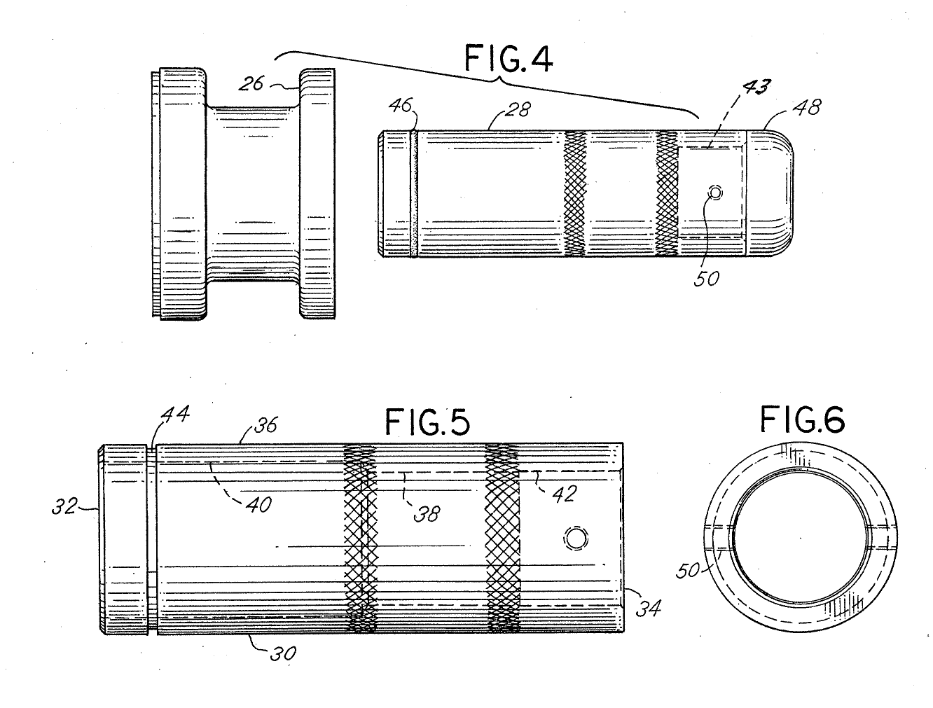

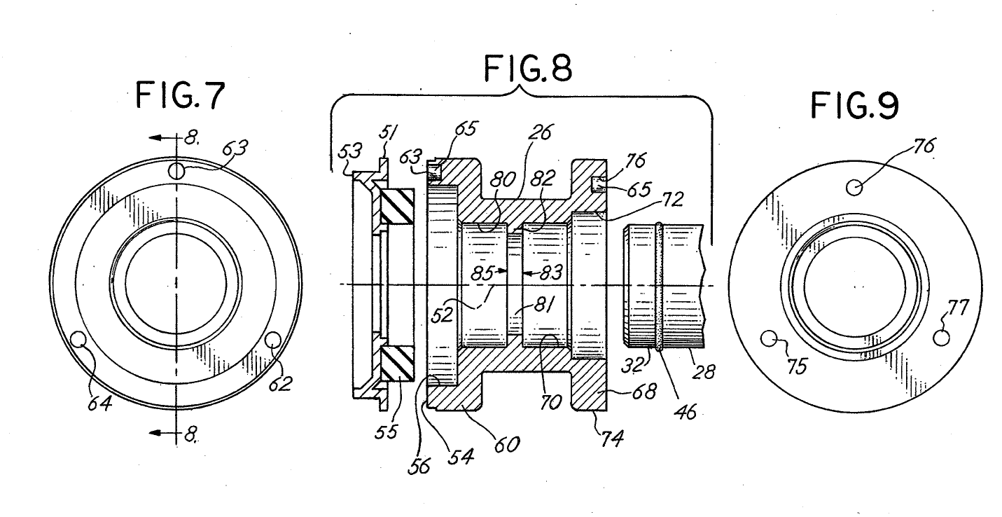

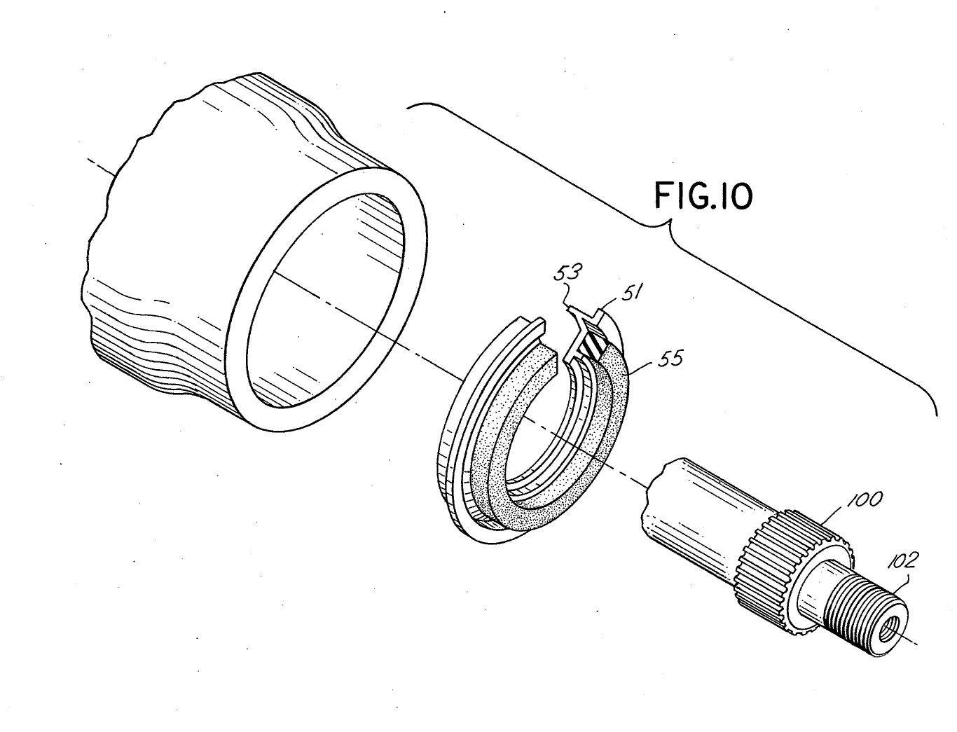

The present invention is depicted in FIGS. 4-12. The embodiment of the present invention is comprised of a unitary driver or a unitary body or body member 26 and a separate, compatible handle 28. The handle 28 is depicted in detail in FIGS. 5 and 6. A typical unitary driver 26 is depicted in FIGS. 7, 8 and 9. FIGS. 10, 11 and 12 illustrate use of the tool.

Referring first to the construction of the handle 28 and FIG. 5, the handle 28 typically comprises a cylindrical housing or tubular body 30 having a leading or drive end 32 and driven or impact end 34. The housing 30 has a uniform diameter outside surface 36 and a throughbore 38. In the embodiment depicted, the throughbore 38 is divided into a greater internal diameter section 40 and a lesser diameter internal section 42 adjacent respectively the drive end 32 and the driven end 34. The greater and lesser internal sections 40 and 42 are approximately equal in axial dimension. The drive end 32 includes an outer recess or circumferential groove 44 for receipt of an O ring 46. The driven end 34 receives a separate cap 48 with a reduced diameter projection or section 49 that slides or fits into the lesser diameter section 42 of the throughbore 38 and which is retained in position by fasteners or set screws 50 that fit through the housing 30 and engage the cap 48. The handle 28 and, more particularly, the cylindrical body or housing 30 is typically made from a steel or aluminum alloy whereas the cap 48 may be comprised of a steel material. The handle 28 in the embodiment depicted includes a uniform outer surface diameter which is cylindrical or circular and may have a knurled surface or surface pattern. However, other configurations may be adopted so long as they are compatible with the driver or body member 26.

FIGS. 7, 8 and 9 depict in greater detail the unitary driver or unitary body or body member 26. Typically the body member or driver 26 is made from an aluminum rod. The body member 26 includes a centerline axis 52, which in the embodiment depicted, is an axis of symmetry 52. The body member 26 further includes a first planar face or end 54, which is transverse or perpendicular to the axis 52 and a first co-axial counterbore 56 extending axially into body member 26 from face 54. The first counterbore 56 extends axially from the first face 54 for a fixed depth adequate to receive a seal or a pinion shaft seal. That is, a pinion shaft seal may include an annular flange 51 as depicted in FIG. 8 and an annular metal housing 53 as well as an axially projecting flexible or rubber pinion shaft seal element 55. The flange 51 may be fitted flush against the face 54 and the pinion shaft rubber seal element 55 will thus be positioned in the annular counterbore 56.

An outer peripheral circular rim 60 of driver 26 extends around the central axis 52. The circular rim 60, includes at least one, but preferably a plurality of three counter sunk bores or holes 62, 63 and 64. Each bore 62, 63, 64 includes a small cylindrical magnet such as a neodymium magnet 65 which is retained therein by epoxy or some other retention or adhesive means. The passages or holes 62, 63 and 64 are arranged at spaced, equal angular positions about axis 52 and in the rim 60 and at equal radial distances from axis 52. The magnets 65 within the passages 62, 63, 64 provide magnetic force to magnetically attract and hold a seal on face 54 surrounding the first counterbore 56. Since most seal housings are made from material which is magnetically attracted, the magnets 65 will retain a seal in a substantially fixed position on and in body member 56. Also, if the seal housing has a configuration that does not incorporate a flange as depicted, the described construction is nonetheless useful for maintaining a seal assembly in position.

The body member 26 further includes an opposite, second end or face 68 which is also transverse or perpendicular to the axis 52. A second counterbore 70 is recessed within the opposite end of the body member 26 and has a diameter or profile of lesser dimension than the profile or diameter of the first counterbore 56. Typically the second counterbore 70 is a co-axial, cylindrical counterbore, but this is not necessarily a limiting feature of the invention inasmuch as other non-cylindrical profiles may be adopted which are compatible with the drive end 32 of handle 28. Thus the second counterbore 70 has a shape and size that may receive the drive end 32 of the handle 28. The axial depth of counterbore 70 is sufficient for the outer O ring 46 to fit into the second counterbore 70 and, as described hereinafter, to accommodate a third, coaxial, pinion shaft seal counterbore or counterbore recess 72.

The second face 68 thus has a construction similar to the first face 54. The second face 68 includes the generally cylindrical co-axial third, annular counterbore recess 72 and typically has a diameter which is distinct from the diameter of the first counterbore 56. The third counterbore 72 also defines an annular or circular outer rim 74 which surrounds the periphery of the counterbore 72 and includes passages 75, 76, 77 that receive embedded magnets 65. The third counterbore 72 has an internal profile which is lesser than the profile of the second counterbore 70. That is, the diameter of the third counterbore 72 is lesser than that of the first counterbore 56.

In the embodiment shown there is a fourth axial counterbore 80 which also has a profile and depth compatible with drive end 32 of handle 28. Further, the counterbores 70 and 80 are coaxial and delimited by an internal, intermediate, typically annular rib 82. The outer end or rim 33 of the drive end 32 will engage against the rib 82 inasmuch as the profile of the counterbores 70 and 80 are each compatible with drive end 32 of the handle 28. Thus, the handle 28 may be inserted into either end of the body member 26, extended into either the second counterbore 70 or fourth counterbore 80, and engaged against respectively either outer rib surface 83 or outer rib surface 85 to thereby effect driving of a pinion shaft seal assembly onto a shaft.

The coaxial counterbores and passage through the annular rib 82 define a throughbore in the body member 26. The first and third counterbores 56, 72 define recesses for a pinion shaft seal. The second and fourth counterbores 70, 80 are each adapted and configured to receive the drive end 32 of handle 28. The throughbore comprised of the counterbores 56, 70, 72, 80 and passage through the annular rib 82 in combination with the throughbore 38 of the handle 28 provide an access opening or passage for a pinion at the end of a shaft.

The magnets 65 retain a seal or seal assembly 49 in position on a face 54, 68 so that the seal assembly 49 may be positioned over or on the pinion shaft in a manner which will enable a hammer or similar tool to strike the cap 48 against the handle 28 inserted into second or fourth counterbores 70, 80 of the body member 26 and thereby drive the seal assembly 49 into position over or around a shaft.

The dimensions of the body member 26 may be altered or changed to support or receive and install various sizes of seals. Thus, the body member 26 depicted in FIGS. 7, 8 and 9 may have various diameters associated with the first and third counterbores 56, 72. A kit of such body members may thus be provided for use with respect to repair of machinery, vehicles and the like over a wide range of shaft seal sizes by providing a range of sizes of the counterbores 56, 72.

The axial dimensions of the various counterbores 56, 70, 72, 80 and the presence of the passage through the annular rib 82 become a factor and desirably are chosen to enable a pinion 100 or shaft extension 102 to project into the body member 26 an adequate distance for proper engagement, placement and driving of the seal assembly 49. In this regard, the handle 28 includes the bores 40 and 42 also designed to accommodate a pinion 100 and/or shaft extension 102 as necessary.

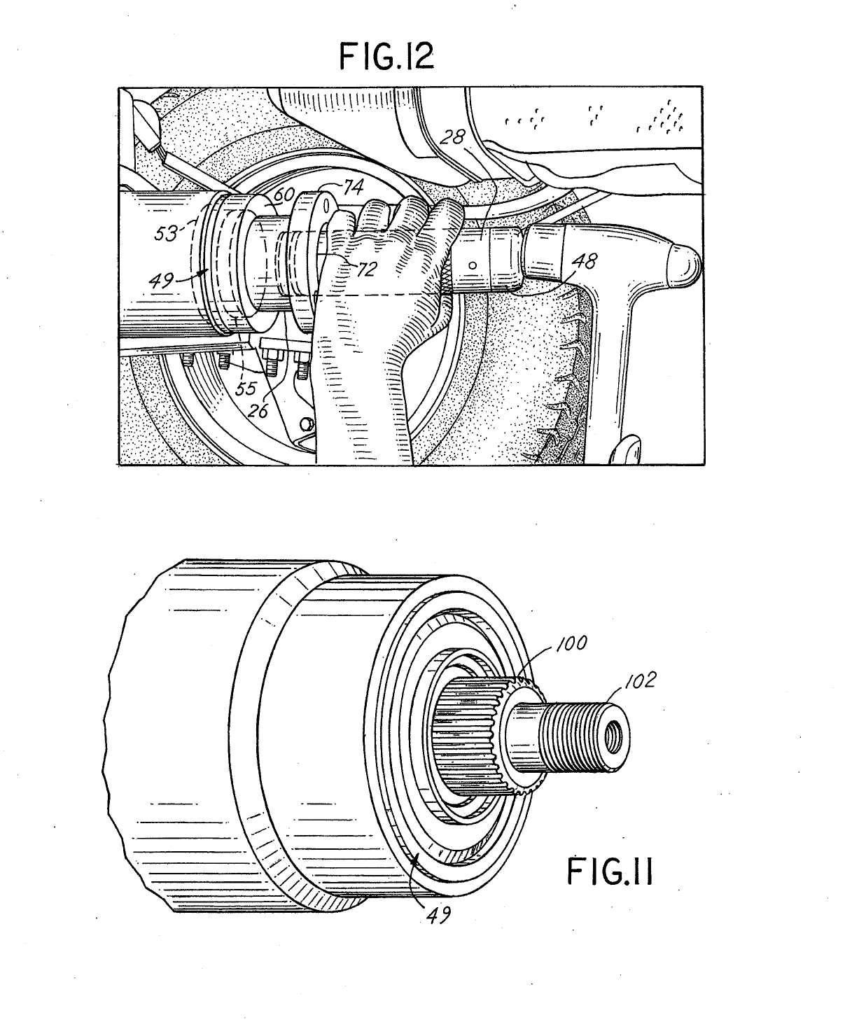

FIG. 12 illustrates a manner of use of the tool. That is the handle 28 is inserted into the body member 26 second or fourth counterbores 70, 80. The body member 26 will have an appropriately sized seal positioned on a face 54 or 68 and retained by the magnets 65. A hammer may then be impacted against the cap 48 to drive the seal assembly 49 into a seal housing and/or over a shaft.

The invention thus comprises the combination of a handle 28 and a separate, typically cylindrically shaped body member 26. The body member 26 is designed to receive and hold a seal on either end face. The opposite end face of the body member 26 is designed to receive the handle 28 in an axial counterbore. The profile of the handle 28 and the receiving counterbores 70, 80 of the body member 26 are compatible. Further the body member 26 is designed to magnetically retain a seal or seal assembly. It should be noted that seals and seal assemblies are available in a myriad of configurations. The drawing thereof is only illustrative of the general construction of a seal or seal assembly. That is such assemblies typically include a flange such as described and an elastomeric seal, but the structure of the seal or seal assembly is not a limiting feature of the invention.

Alternations, changes and variations of the construction may be effected without departing from the spirit and scope of the invention. The shape, depth and size of the counterbores described may be altered e.g., they need not be annular or cylindrical. The outer configuration of the body member 26 may be altered as may the shape and structure of the separate handle 28. The invention is therefore limited only by the following claims and equivalents thereof.

What is claimed is:

1. A pinion shaft seal driver tool assembly comprising:
a) a unitary body member having a longitudinal, centerline axis with a generally planar first face transverse to the axis at a first end of said body member and a second face at a second end of said body member, a first generally coaxial counterbore at the first end having a first dimension and shape to define a first generally peripheral rim surrounding, at least in part, said first counterbore, said rim including a magnet element to a magnetically retain a seal on said first end, a second coaxial counterbore in the second end, said second counterbore having a configuration and extending into said body member; and
b) a separate handle for insertion into said second counterbore, said separate handle including a leading end and an opposite impact end, said leading end having a generally compatible configuration with said second counterbore, whereby a seal may be retained in position on said first end and driven by said handle positioned in said second counterbore when impacted at said impact end.

2. The driver assembly of claim 1 wherein said body member further includes a third generally coaxial counterbore in said second end intermediate the second face and the second counterbore, said third counterbore having a bore profile different than said first counterbore profile, and said body member further including a fourth generally co-axial counterbore intermediate the second counterbore and the first counterbore, said fourth counterbore having a profile that is compatible with the configuration of the leading end, said fourth counterbore separated from the second counterbore by a rib member.

3. The driver assembly of claim 1 wherein said second face is generally parallel to said first face.

4. The driver assembly of claim 2 including a peripheral rim surrounding at least in part said third counterbore, said third counterbore peripheral rim including a magnetic element to magnetically retain a seal on said second end.

5. The driver assembly of claim 2 wherein said second face is generally parallel to said first face.

6. The driver assembly of claim 5 including a peripheral rim surrounding at least in part said third counterbore, said third counterbore peripheral rim including a magnetic element to magnetically retain a seal on said second end.

7. The driver assembly of claim 2 wherein said counterbores are cylindrical and coaxial.

8. The driver assembly of claim 7 wherein said second and fourth counterbores have an equal diameter.

9. The driver assembly of claim 6 wherein said counterbores are cylindrical and coaxial.

10. The driver assembly of claim 9 wherein said second and fourth counterbores have an equal diameter.

11. The driver assembly of claim 2 wherein said rib member comprises a generally coaxial counterbore having a profile of a lesser dimension at least in part than the second and fourth counterbores.

12. A pinion shaft seal driver tool assembly comprising:
a) a unitary body member having a longitudinal, centerline axis with a generally planar first face transverse to the axis at a first end of said body member and a second face at a second end of said body member, a first generally cylindrical, generally coaxial counterbore at the first end having a first diameter to define a first peripheral rim surrounding, at least in part, said first counterbore, said rim including a magnet element to a magnetically attract a seal on said first end, a second generally coaxial counterbore in the second end, said second counterbore having a configuration and extending into said body member;
b) a separate handle for insertion into said second counterbore, said separate handle including a leading end and an opposite impact end, said leading end having a generally compatible configuration with said second counterbore, whereby a seal may be retained in position on said first end and driven by said handle positioned in said second counterbore when impacted at said impact end; and
said body member further including a third generally coaxial counterbore in said second end intermediate the second face and the second counterbore, said third counterbore having a bore profile different than said first counterbore profile, and said body member further including a fourth generally co-axial counterbore intermediate the second counterbore and the first counterbore, said forth counterbore having a profile that is compatible with the configuration of the leading end, said fourth counterbore separated from the second counterbore by a rib member.

13. The driver assembly of claim 12 wherein said second face is generally parallel to said first face.

14. The driver assembly of claim 12 wherein said counterbores have a generally cylindrical configuration.

15. The driver assembly of claim 14 wherein said second face is generally parallel to said first face.

16. The driver assembly of claim 12 wherein said rib member comprises a generally coaxial passage between the second and fourth counterbores.
